(19) United States
(12) Patent Application Publication
(10) Pub. No.: US 2003/0220885 A1
(43) Pub. Date: Nov. 27, 2003

(54) Collectible item authentication and ownership system and method of selling collectible items

(76) Inventors: Bruno Lucarelli, Tinton Falls, NJ (US); Alan Kaye, Ryebrook, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/298,176

(22) Filed: Nov. 15, 2002

Related U.S. Application Data
(63) Continuation of application No. 10/109,066, filed on Mar. 28, 2002.
Application No. 10/109,066 is a continuation of application No. 09/929,872, filed on Aug. 14, 2001.
Application No. 09/929,872 is a continuation of application No. 09/708,153, filed on Nov. 8, 2000, now abandoned.
(60) Provisional application No. 60/201,812, filed on May 4, 2000.
(60) Provisional application No. 60/209,324, filed on Jun. 5, 2000.

(51) Int. Cl. G06F 17/60

(52) U.S. Cl. 705/64

(57) ABSTRACT

An on-line system for authenticating a collectible item or other type of memorabilia is provided which includes a web page on a on-line title company's website for the collectible item, wherein the web page displays a digital image of the collectible item, written description of the item, and the current owner of the collectible item. The web page is assigned a unique URL address and unique password. The web page may be viewed by the general public via the internet through the URL address in read only format. In the event of a transfer of ownership of the collectible item, the new owner is given the URL address for the web page, and the password. The new owner may then edit the owner information field on the web page by entering the password provided to him or her by the previous owner to update the owner's information displayed on the web page. In a further aspect of the invention, the collectible item is an individual video and audio segment of a celebrity reciting a greeting to an individual chosen from a selection of available greetings, which is saved on a VHS cassette or DVD, and may also be saved in a computer file and then displayed on a web page and viewed by the general public as set forth above.

This application claims priority from U.S. Provisional Application Serial Nos. 60/201,812, filed May 4, 2000 and entitled METHOD OF SELLING AUTOGRAPHED ITEMS and 60/209,324, filed Jun. 5, 2000 and entitled ONLINE COLLECTIBLE AUTHENTICATION AND OWNERSHIP SYSTEM the entire disclosures of which are hereby incorporated by reference.

### FIELD OF THE INVENTION

The present invention relates to the field of authentication of collectible items and method of selling collectible items.

### BACKGROUND OF THE INVENTION

Articles that are created in a limited number are in many cases collected by individuals with a particular interest in the field that article represents, such as toys, lithograph or other artwork, sports memorabilia, stuffed animals, historical items or items owned by notable and famous figures. The value of these items is directly related to the number of items that are existing at the moment the valuation is performed. The internet has also become a popular venue for owners of items previously described to sell or for collectors seeking these items to purchase the same. Unfortunately, the anonymous nature of the internet and inherent value of these type of limited editions has led to rampant counterfeiting in many collectible categories and as a result, the origin of a particular item becomes important in any collectible transaction.

U.S. Pat. Nos. 5,267,756 and 5,380,047 purports to disclose an authentication system which includes a tamper-proof hologram affixed to the items and having a unique ID number. A master record of these hologram ID are kept at a registration entity.

U.S. Pat. No. 5,971,435 purports to disclose a method and system for verifying the authenticity of an autograph and which includes a database having such information as the signing of the items, record of code numbers, and identification of the owner of the article.

U.S. Pat. No. 5,306,049 purports to disclose a sports memorabilia authentication kit which includes a collectible item with a fingerprint, preferably a thumbprint, of an athlete thereon, and a certification card also containing the fingerprint of the notable athlete as well as information identifying the athlete indicated thereon.

### SUMMARY OF THE INVENTION

There is a need in the field of collectible item authentication systems for a system which not only provides high security against the fraudulent duplication of a collectible item but which is also easily accessible to the general public and which allows them to search for a collectible item of interest to them. The prior art focuses on providing highly secure methods and systems to prevent the unauthorized duplication of collectible items. One of the drawbacks of the prior art authentication systems and methods is that they do not provide an easily accessible system to the general public in which a potential consumer looking for a particular kind of collectible item may conduct a search of an on-line company's website to see if that type of item is registered with the on-line title company and who the current owner is.

Specifically, in the prior art there are “tamper resistant” holograms and fingerprints affixed to the collectible items for providing high security with the information regarding the collectible item being stored in the title registration company's computer database. However, a member of the general public would not know that a collectible item existed unless being informed by the person trying to sell the item because this information is not directly available to the public but rather may only be obtained by contacting the company by telephone or mail to receive this information from the database. A potential customer doing a search, say on the internet, would not be able to locate the items authenticated by the prior art methods.

In accordance with a first embodiment of the present invention, an on-line system for authenticating a collectible item or other type of memorabilia is provided which includes a web page for the collectible item having a unique URL address assigned to the web page. The on-line system further includes a unique password assigned to the current owner of the collectible item for editing ownership information on the web page. In use, a collector has a collectible item authenticated. An on-line title company then creates a web page for the collectible item and assigns the web page a unique URL address. Further, a unique password is assigned to the title company and to the current owner of the collectible item for allowing the title company and current owner to edit the owner information field of the web page, including the name and e-mail address of the owner. Read only access is permitted for the other members of the public. If the current owner of the collectible item wishes to transfer ownership of the collectible item to another party then he or she may effectuate this transfer by transferring physical possession of the collectible item along with a physical representation such as a paper document, certificate, etc. having the URL address, password, and instructions on how to log on to the web page, indicated thereon. The new owner would then connect with the online title web page either through the online title company's website or directly through the URL address assigned to the collectible item. Once connected to the web page the new owner would enter the name of the previous owner and also the password provided on the physical representation, into the information fields provided on the web page. Subsequently, the user would be prompted to enter their name, e-mail address, and any other relevant information. This information would be sent to the on-line title company's computer electronically, where the owner information would then be updated by the on-line title company by replacing the information about the previous owner on the web page with the new owner's information and then a confirmation of ownership would be sent to the new owner. The new owner may also request a new password to supercede the old password of the previous owner.

Further, there is also a need in the prior art for authentication systems and methods which provide highly personalized celebrity memorabilia offered on a large scale to the general public. In particular, a system which provides the consumer with a personalized video image and audio of a celebrity such as a professional sports athlete autographing a piece of sports apparel or equipment and or of a celebrity greeting a recipient of the consumers choice by the recipient's first and/or last name, nickname, city, or by other identifying features.

In accordance with a second embodiment of the present invention, a system for creating and merchandising celebrity greetings is provided, which includes a video camera for the continuous recording of a video image and audio of the celebrity reciting a plurality of personalized greetings and a VHS cassette, DVD, or other removable storage device for storing the video image and audio of the celebrity reciting the greetings captured by said video camera. The system further includes a video editing system for editing the video image and audio of each greeting on said VHS cassette, DVD, or other removable storage device onto a separate blank VHS cassette, DVD, or other removable storage device and the system also includes a computer based video editing system. The video editing system is linked to the computer based video editing system, with the computer based video editing system encoding each individual greeting from the VHS cassette, DVD, or other removable storage device into a separate file, one video computer file per greeting.

Preferably, the system, also includes a website sponsored by the company selling the greetings in which there is a separate web page for each greeting, and with a digital image of the video greeting displayed on the web page and downloadable by the customer. Each web page is assigned a unique URL address and is accessible by the general public in read only format so that they may view the greeting and find out who the owner is. The web page is also assigned a unique password so that a subsequent purchaser of the video greeting to use in order to edit the current ownership information with their information. In accordance with other embodiments of the present invention, the greeting is not stored on a VHS, DVD, or other removable storage device, and is purchased only on the web-page for downloading by the customer or his designee.

### BRIEF DESCRIPTION OF THE DRAWINGS

FIG. 1 is a flow diagram which depicts the creation of an a collectible item comprising a baseball autographed by a famous baseball player with an identifying mark thereon according to the present invention..

FIG. 2 depicts a collectible item comprising a baseball autographed by a major league baseball player.

FIG. 3 depicts the collectible item in a protective casing along with a written description of the collectible item.

FIG. 4 depicts a digital image being taken of the collectible item and storing the image.

FIG. 5 depicts the digital image and written description of the collectible item being sent to the title company for the creation of an on-line title.

FIG. 6 is a flow diagram which depicts the assigning of a unique URL address to the collectible item.

FIG. 7 depicts the title company's a template web page template for the collectible item, including the digital image of the collectible item, and written description for item.

FIG. 8 depicts the template of the title company's web page for the collectible with the URL address assigned to the web page.

FIG. 9 depicts the process of inserting the digital image and written description of the collectible item onto the template of the title company's web page.

FIG. 10 depicts the insertion of one or more information fields specifying the owner of the collectible items information.

FIG. 11 depicts how access to the title company's web page may be obtained through the internet via the unique URL address assigned to the web page.

FIG. 12 depicts a change of ownership of the collectible item.

FIG. 13 depicts new owners receipt of physical representations which indicate the unique URL address for accessing the web page of the collectible.

FIG. 14. depicts physical representations which indicate the unique password assigned to the web page and instructions on how to claim ownership of the collectible item.

FIG. 15 depicts a new owner of a collectible item logging onto the web page for the collectible item via the unique URL address assigned to the web page.

FIG. 16-A depicts a field for entering the password assigned to the web page

FIG. 16-B depicts the screen that follows when the password assigned to the web page is entered.

FIG. 17 depicts the transmission of the new owner's information to the on-line title company's computer.

FIG. 18 depicts the on-line title company receiving the new owners information and updating. the web page.

FIG. 19 depicts the new owner receiving a confirmation via e-mail of the change of ownership.

FIG. 20 is a flow chart illustrating the steps of practicing the first embodiment of the present invention.

FIG. 21 depicts a collectible item, in this instance a baseball autographed by Babe Ruth, which a collector is seeking to have an on-line title registration created for the collectible item.

FIG. 22 depicts the on-line title company's website having instructions on how to have an on-line title created for a collectible item.

FIG. 23 depicts another page of the title company's web page which provides a listing of pre-approved appraisers.

FIG. 24 is a flow diagram of how a collector may contact an appraisal house.

FIG. 25 depicts the collector shipping the collectible item to the appraisal service for evaluation.

FIG. 26 is a flow diagram of what happens when the appraisal house finds a collectible item to be authentic and also when it finds one not be authentic.

FIG. 27-A is a flow diagram of a digital image being taken of the collectible item and a written description of the item.

FIG. 27-B depicts the appraisal house sending the digital image and written description of the collectible item to the appraisal house.

FIG. 28 depicts a template of the title company's web page for the collectible item, in which the digital image and written description of the collectible item are cut and pasted thereon.

FIGS. 29-31 depict the title company's web page for the collectible item with the digital image of collectible item and additional fields for the current owner's information of the item.

FIG. 32 is a flowchart of the steps illustrating the procedure for finding an appraiser to authenticate a collectible item and subsequently have an on-line title created, in accordance with the present invention.

FIG. 33 depicts a table indicating the type of information that a consumer would receive before deciding upon which celebrity greeting(s) to purchase.

FIG. 34 depicts a sample order form for purchasing a celebrity video greeting in accordance with the present invention.

FIG. 35 is a flow chart illustrating the steps in practicing the second embodiment of the present invention.

### DETAILED DESCRIPTION OF THE PREFERRED EMBODIMENTS

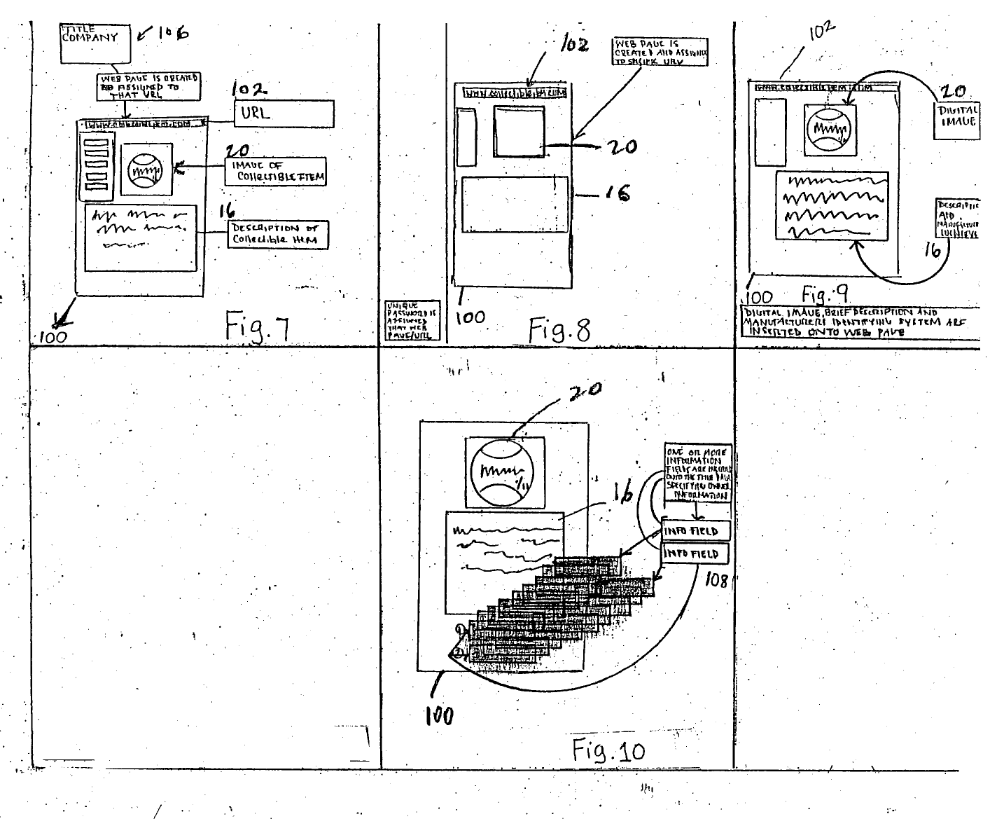

FIGS. 1-18 refer to an embodiment of the present invention for an on-line title registration system for a collectible item 10. The on-line title registration system includes a collectible item 10, a written description 16 of the collectible item 10, a website having a web page 100 for the collectible item 10, a URL address 102 assigned to the web page 100, and password 104 assigned to a current owner of the collectible item and to title company 106.

Specifically, depicted in FIG. 1 is the collectible item 10, in this instance a baseball, created by a manufacturer and autographed 12 by a current or former major league baseball player. An identifying mark 14, in this case a serial number, is imprinted on the collectible item 10, but, besides being imprinted, the identifying mark 14 may be placed on the collectible item 10 by any other securing means known in the art, to identify how that item is part of a limited edition series. Further, the present invention is not limited to baseballs or major league baseball. Rather, the present invention may be used to sell and authenticate any type of collectible item, including but not limited to sports memorabilia, other memorabilia, antiques, artwork, vintage cars, or any other item which, due to its unique nature, and/or limited availability, is considered valuable.

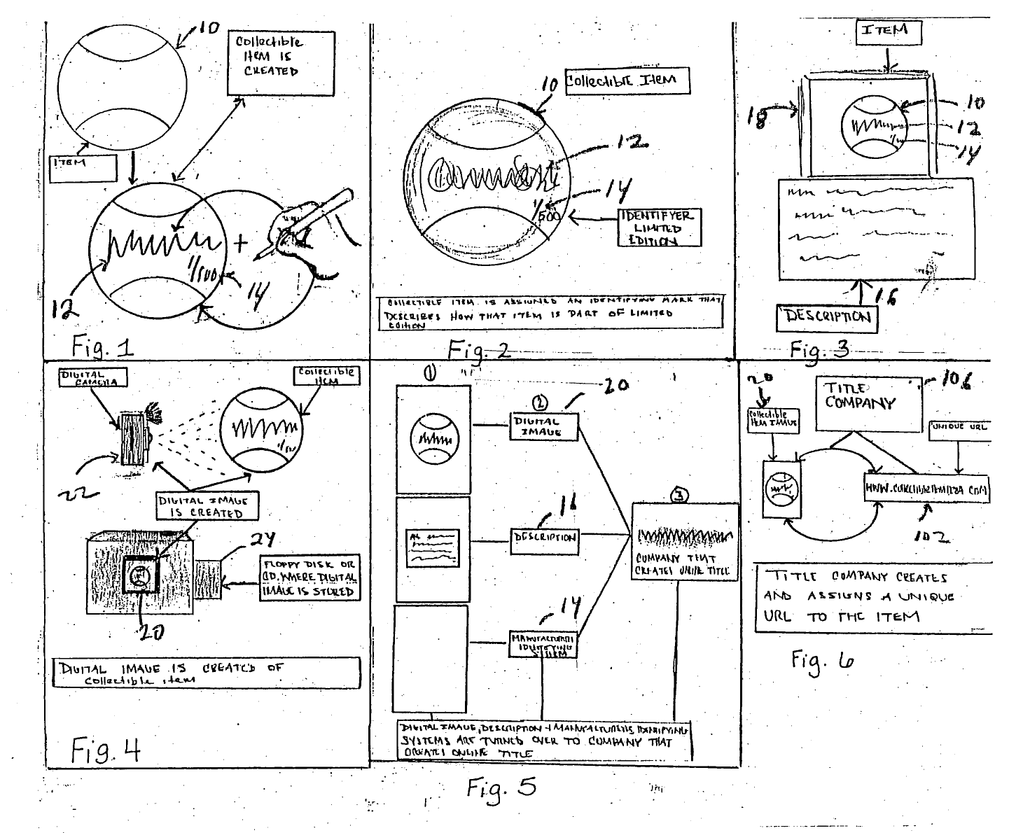

As shown in FIG. 3, a written description 16, describing what characteristics of the collectible item 10 make it unique, may accompany the collectible item 10. Typically, the written description 16 ranges from about 50 to 80 words in length. Further illustrated in FIG. 3 is the collectible item 10, i.e. baseball, located within a protective casing 18, for preserving the condition and value of the collectible item 10.

The above embodiment further includes a digital image 20 of the collectible item 10, as shown in FIG. 4, taken using a digital camera 22. The digital image 20 is saved on a storage element 24 such as a computer diskette, CD rom, fixed hard disk, or other equivalent thereof known in the art for storing such images. Subsequently, as shown in FIG. 5, the saved digital image 20, the written description 16, and the identifying mark 14 are provided to the title company 106 for creation of an on-line title of the collectible item 10 on a web page 100 of the title company's website.

FIG. 7 shows the title company's web page 100 displaying the digital image of the collectible item 10. Unique URL address 102 (eg. www.collectibleitem1234.com) is assigned to the web page 100 as indicated in FIG. 6. In addition to the digital image 20, the written description 16 may also be placed on the web page 100 if desired, as shown in FIGS. 7-9. Further, as shown in FIG. 10, one-or more information fields 108 specifying the owner's information are located on the title web page 100. An individual may gain access to view the web page 100 for the collectible item 10, as shown in FIG. 11, via the internet either directly through the URL address 102 assigned to the collectible item 10 or indirectly through the title company's web site. The web pages 100 can be altered by, or with the permission of the title company. In cases in which the manufacturer submits the image 20 to the title company 106, the manufacturer is listed on the web page 100.

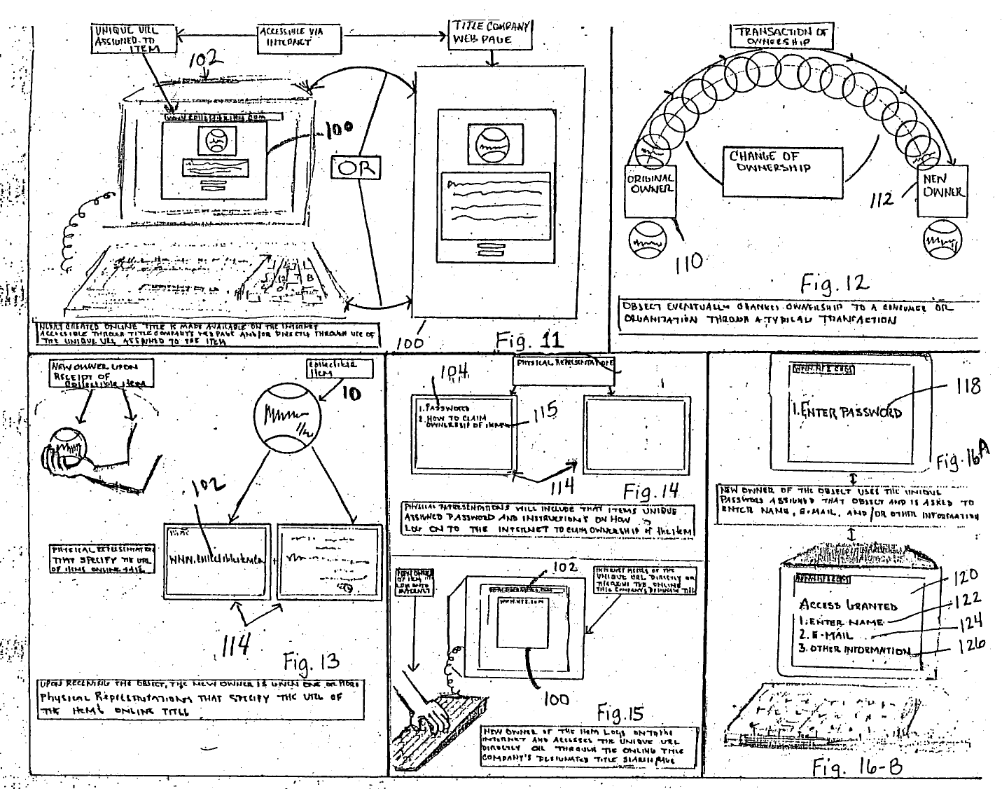

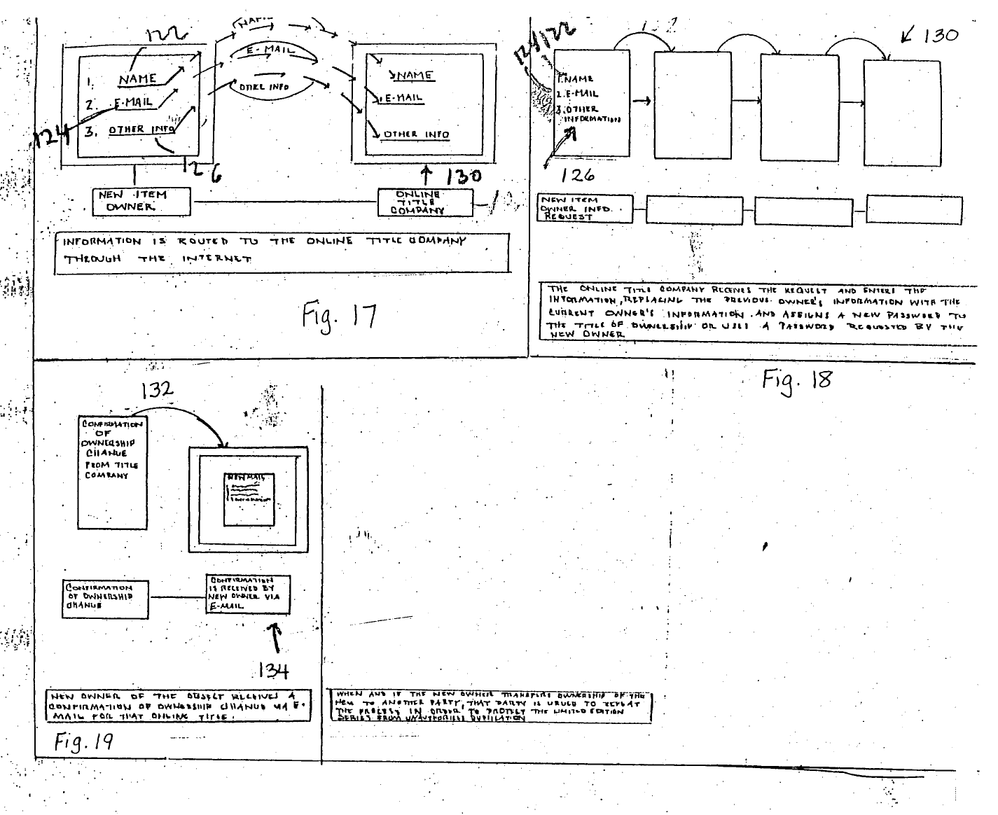

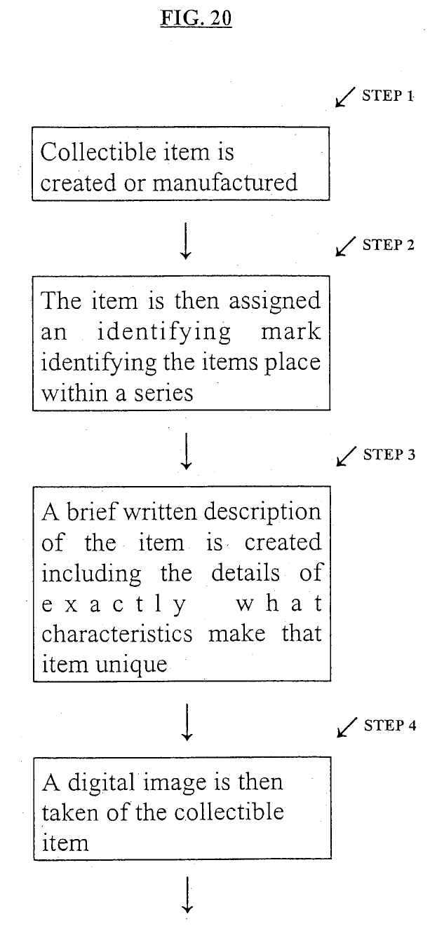

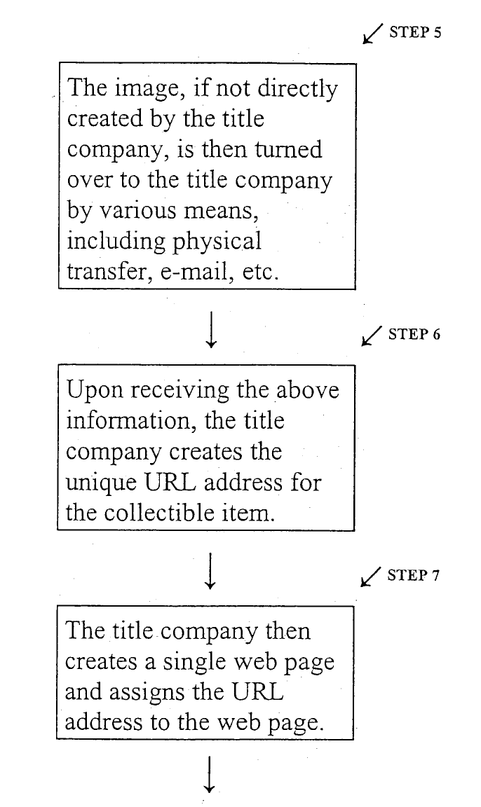

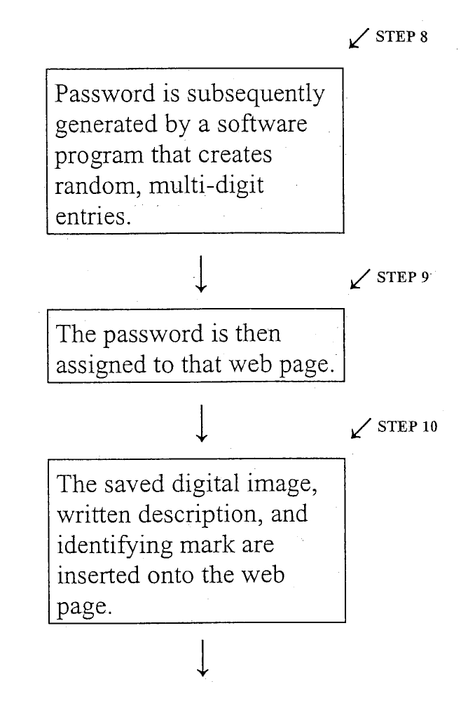

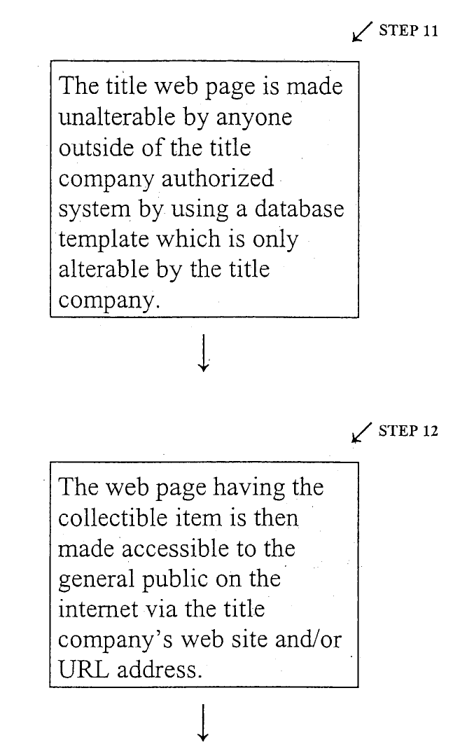

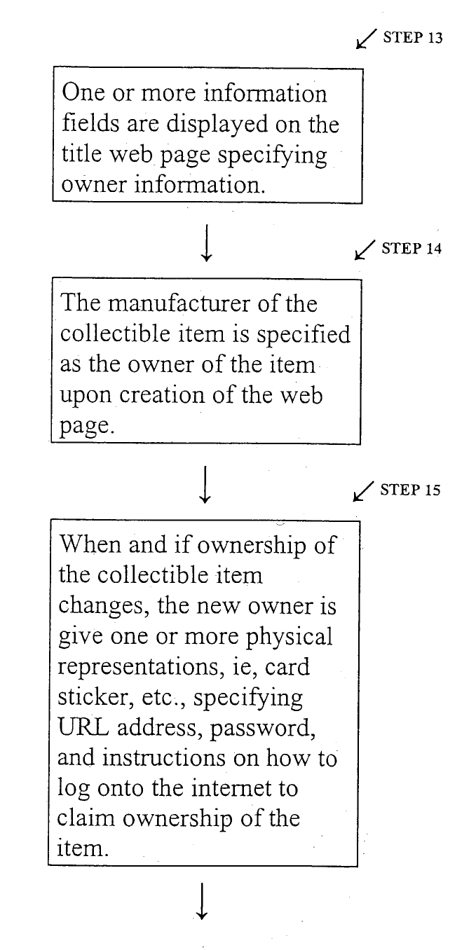

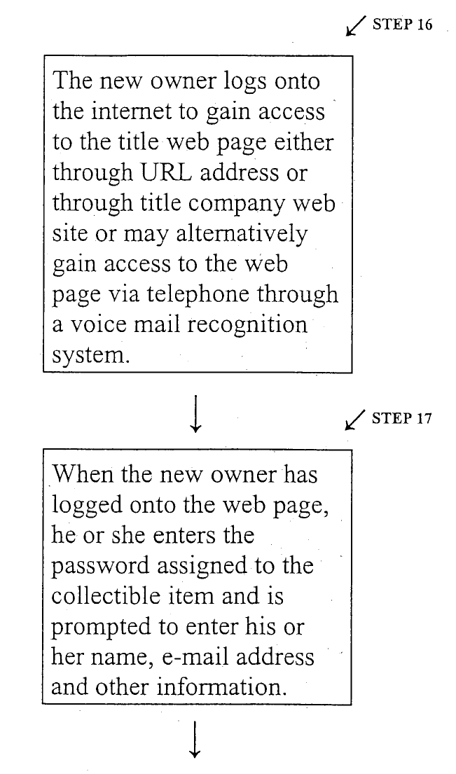

FIG. 12 depicts a change in ownership of the collectible item where the collectible item is transferred from an original owner 110 to a new owner 112. In this regard, FIGS. 13-19 illustrate the procedure for effecting a change in ownership, including how this change is recorded on-line. Specifically, FIG. 13 shows the collectible item 10, i.e. baseball, in the hand of the new owner and two certificates 114 which contain the unique URL address 102 to access the title company's web page 100 for the collectible item 10, indicated thereon. The certificate or certificates 114 may also contain thereon, as shown in FIG. 14, the unique password 104 assigned to the collectible item 10 and instructions 115 on how to log on to the title web page to claim ownership of the collectible item 10.

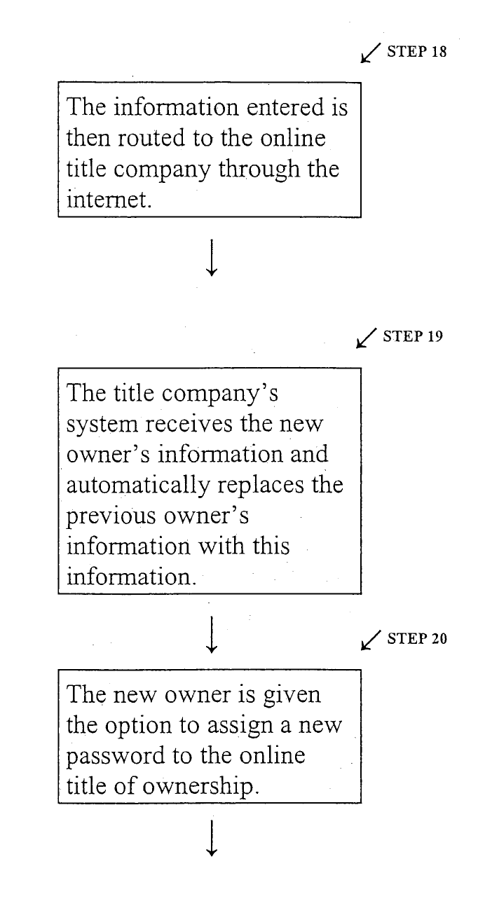

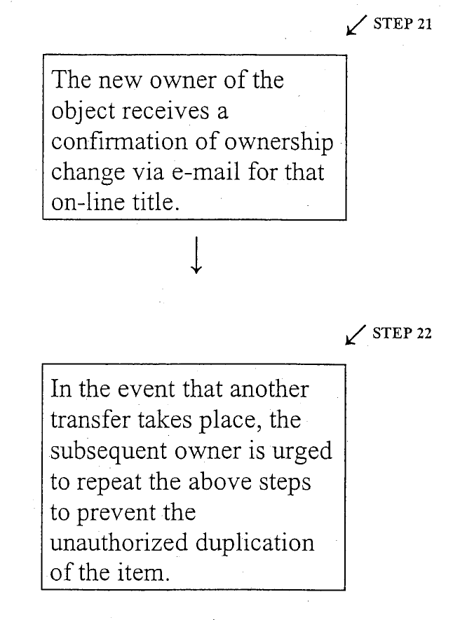

As shown in FIG. 15, the new owner using a computer or other device for accessing the internet, logs onto the title company's web page 100 for the collectible item 10 using the instructions 115 and URL address 102 provided on the certificate 114. Alternatively, as mentioned above, the new owner 112 may also access the web page 100 through the title company website. The new owner 112 will then see on his or her computer screen 116, a field 118 to enter a password, as shown in FIG. 16-A, which is the password provided on the certificate. Once, this information is entered, another screen 120 follows (shown in FIG. 16-B), which indicates that access has been granted and prompts the user to enter his or her name 122, e-mail address 124, and other relevant information 126. In accordance with a further aspect of the present invention, the title web page may also be accessible by the telephone through a voice recognition software system in which the new owner dials a certain telephone number at the online title company and then recites the URL address assigned to the collectible item and listens to the registration instructions and then specifies his or her name, e-mail address, and other requested information.

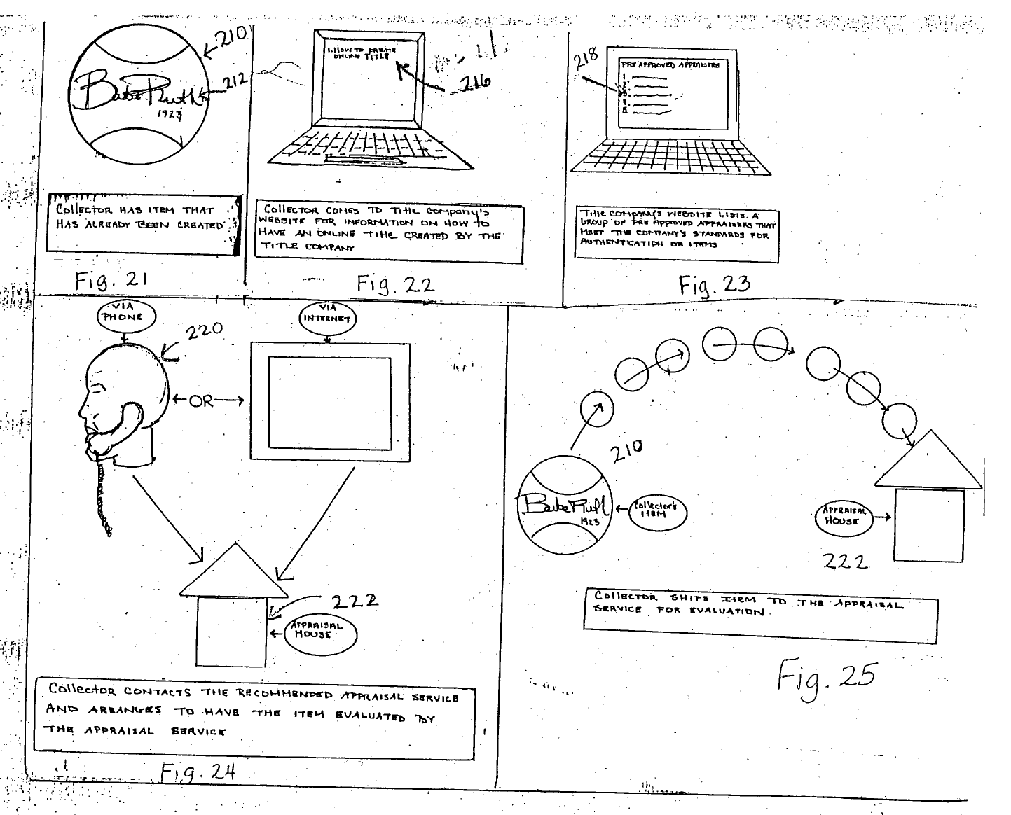

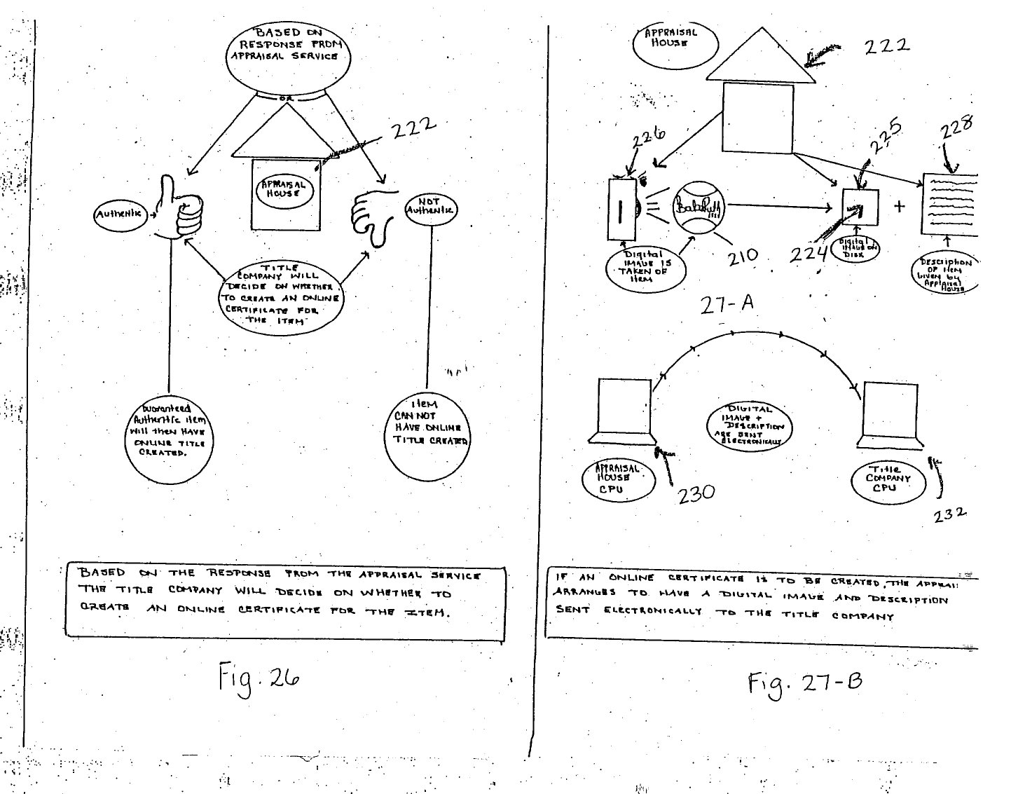

The name 122, e-mail address 124, and other information 126 of the new owner 112 received by computer entry or by way of the telephone is then transmitted to the on-line title company's system 130, as shown in FIG. 17. Once this new information is received by on-line title company's computer system 130, it replaces the current owner's information on the title company's web page, as shown in FIG. 18. A confirmation 132 of the change of ownership, as shown in FIG. 19, is then sent to the new owner 112 via e-mail 134.

In addition, in accordance with further aspects of the present invention, the on-line title company 106 or host's website, which includes all of the web-page(s) 100 for all of the authenticated collectible items, is preferably searchable via a text search engine so that any user can freely search the website for items. of interest. In other embodiments, each web page 100 can have access restricted to system users approved by the title company, and/or to individuals designated by the owner of each collectible.

Further, in accordance with another aspect of the present invention, collectible items on the online title companys or host's website can be entered into an on-line auction through a simple online auction registration process that automatically lists the collectible item 10 in a separate auction area of the host's web site. Preferably, the current owner 110 of the item agrees, as a condition for utilizing the on-line title registration system, that he or she will only use the host's on-line auction system to sell the item. In any event, the owner can sell the item on their own at any time, provided that a third party on-line auction site is not used.

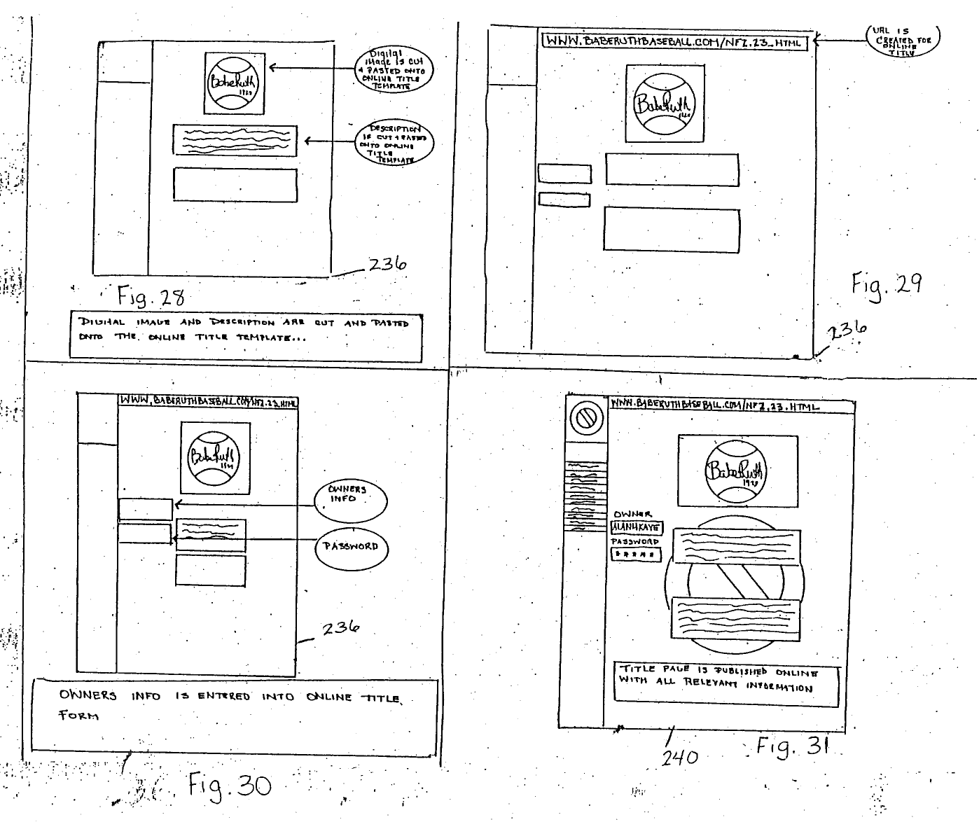

The steps to be followed in practicing the present system for authenticating collectible items are set forth in the flow diagram of FIG. 20. In step 1, the collectible item 10 is created or manufactured by the on-line title company 106 or host. The item 10 is then assigned an identifying mark 14, such as a serial number or a number identifying that objects place within the framework of a series, step 2. A brief written description 16 of the item is created, including the details of exactly what characteristics make that item 10 unique, step 3. A digital image 20 is then taken of the collectible item 10, step 4. This image 20, if not directly created by the title company 106, is then provided to the title company 106 by various means, including physical transfer, e-mail, etc, step 5.

Upon receiving the above information, the title company 106 creates the unique URL address 102 for the collectible item 10, step 6. The title company 106 then creates a single web page 100 and assigns the URL address 102 to the web page 100, step 7. Password 104 is subsequently generated by a software program that creates random, multi-digit entries, step 8. The password 104 is then assigned to that web page 100, step 9.

Subsequently, the saved digital image 20, brief written description 16, and identifying mark 14 are inserted onto the title web page 100, step 10. The title web page 100 is made unalterable by anyone outside of the title company 106 authorized administrative system by using a database template 1 that can only be altered by the company controlling the database, step 11. The web page 100 for the collectible item 10 with the URL address 102 assigned to the web page 100, is then made accessible to the general public on the internet via the title company's website and/or URL address 102, step 12. Further, one or more information fields 108 are displayed on the title web page 100 specifying owner information, step 13. The manufacturer of the collectible item 10 is specified as the default owner of the item 10 upon creation of the web page 100, step 14.

Finally, when and if there is a change in ownership of the collectible item 10, the new owner 112 is given one or more physical representations 114, i.e. card, sticker, certificate, piece of paper, etc. that specifies the URL address 102 of the online title web page 100, the assigned password 104, and instructions 115 on how to log on to the internet to claim ownership of the collectible item, step 15. The new owner of the collectible item logs onto the internet and accesses the web page 100 for the collectible item 10 directly by way of the URL address 102 or indirectly through the online title company's designated title search page or alternatively may access the web page via telephone using voice recognition, step 16. When the new owner 112 has logged onto the title web page 100, he or she enters the password 104 assigned to the collectible item 10 on the web page 100, and is prompted to enter his or her name 122, e-mail address 124, and/or other information 126 via an on-line registration form, step 17.

This information entered is then routed to the online title company through the internet step 18. The title company's system receives the new owner's information and automatically replaces the previous owner's information with. this information, step 19. Further, the new owner is given the option to assign a new password to the online title of ownership, step 20. Finally, the new owner of the object receives a confirmation of ownership 132 change via e-mail for that on-line title, step 21.

In the event that another transfer of ownership takes place, the subsequent owner is urged to repeat the above steps to prevent against any unauthorized duplication of the collectible item 10, step 22.

The above embodiment described a system and method for having an on-line title made for a collectible item created by the on-line title company. However, the present invention also encompasses situations in which a collectible item has been created by someone other than the on-line title company and a collector seeks to have an on-line title created for that collectible item. This particular situation is illustrated in FIGS. 21-31.

Specifically, FIG. 21 depicts a collectible item 210, in this instance, a ball signed 212 by Babe Ruth, which the owner desires to have an on-line title company 214 create an on-line title for the collectible item 210. FIG. 22 shows a computer illustration of an on-line title company's website 216 which indicates how to create an online registration. The website 216 also contains a list of appraisers 218 to contact, as shown in FIG. 23, to have the collectible item 210, in this case the baseball, authenticated. In FIG. 24, an illustration is given of a collector 220 contacting an appraisal house 222 by telephone and/or e-mail to have the collectible item 210 evaluated by the appraisal house 222. The collectible item is shipped to a chosen appraisal house 222, as depicted in FIG. 25. The appraisal house 222 shown in FIG. 26 determines whether or not the collectible item submitted is authenticated, if it is then an on-line title will be created, but if not then no title is created. FIGS. 27A-B, illustrate the situation where the appraisal company 222 has found that the collectible 210 is indeed authentic and where the appraisal house 222 takes a digital image 224 of the item 210, using a digital camera 226, stores the image 224 on a storage element 225 as a computer diskette, CD rom, fixed hard drive, or the like, prepares a written description 228 of the collectible item 210, and submits the image 224 and description 228 to the on-line title company 214 electronically from its computer 230 to the title company's computer 232 . FIG. 28 depicts the template 236 used for creation of the title company web page.0 240, and the digital image 224 and description 228 which are cut and pasted onto template 236. FIGS. 29-30 further illustrate the owner's information cut and pasted onto template 236. Finally, FIG. 31 illustrates the published on-line title web page 240 for the collectible item 210, similar to web page referred to in the embodiment of the present invention represented in FIGS. 1-18.

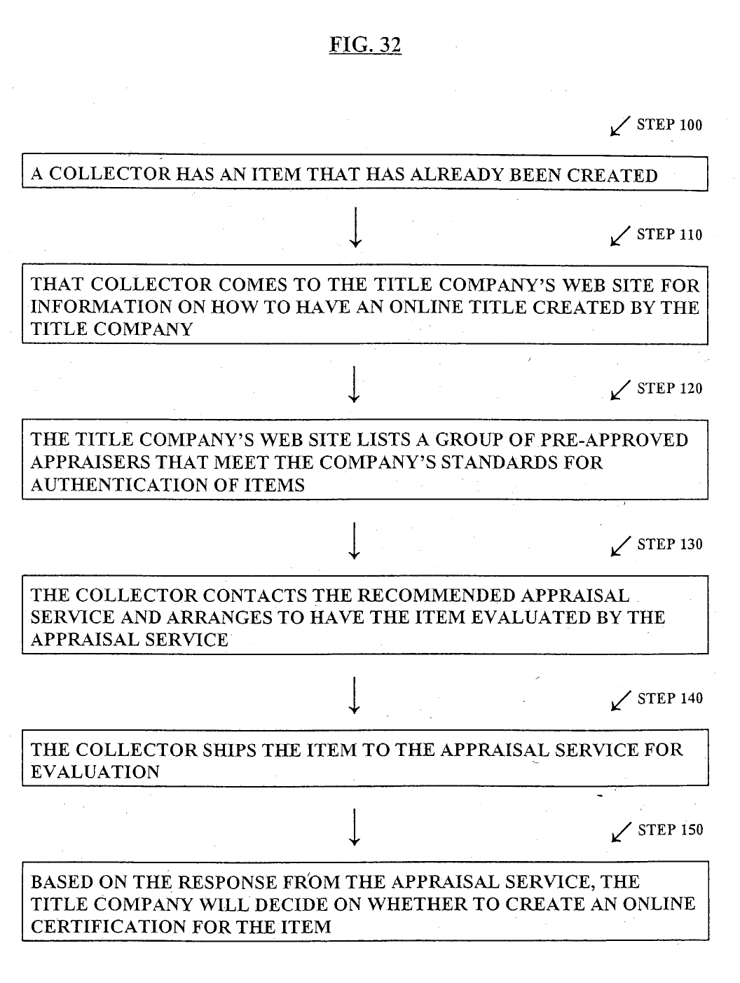

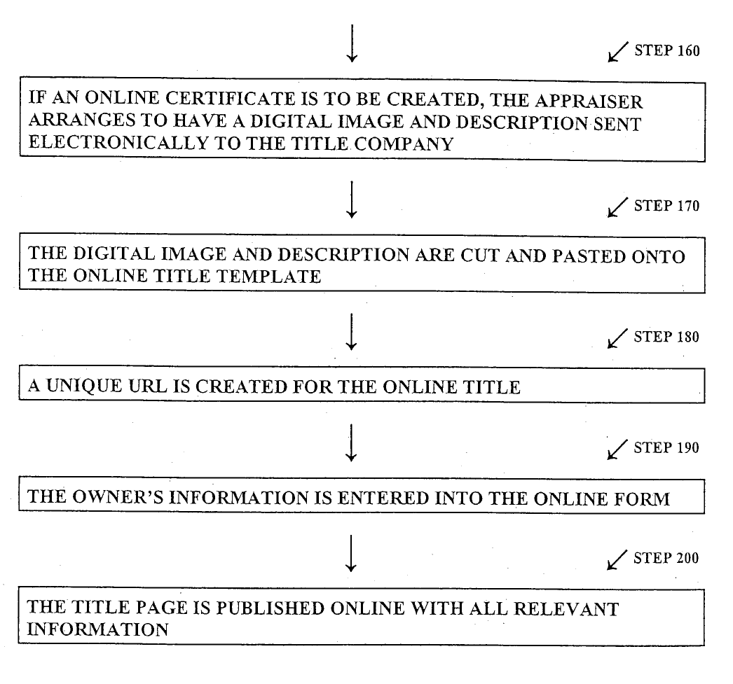

An example of the specific steps a collector would take in order to have an on-line title registration created for a collectible item which was not manufactured by the on-line title company itself, is set forth in FIG. 32. In step 100, a collector 220 has an item 210 that has already been created. The collector comes to the title company's website 216 for information on how to have an on-line title created by the title company, step 110. On the title company's website 216, the collector 220 views a list of a group of pre-approved appraisers 218 that meet the company's standards for authentication of collectible items 210, step 120. The collector then contacts an appraisal house 222 recommended by the website 216 to have the collectible item 210 evaluated, step 130. Further, the collector 220 then ships the collectible item 210 to the appraisal house 222 for evaluation, step 140.

Based on the response from the appraisal house 222, the title company will decide on whether to create an on-line title for the collectible item 210, step 150. If an on-line title is to be created, the appraiser arranges to have a digital image 224 and written description 228 of the collectible item 210 sent electronically to the title company, step 160.

When the digital image 224 and written description 228 are received by the on-line title company, they are cut and pasted onto the online title web page template 236, step 170. A unique URL is then created for the web page, step 180. The owner's information is entered into the on-line form, step 190. The title web page 240 is published on-line with all relevant information, step 200, thee system operates in the same manner as described above with respect to steps 8-13, and 15-22 of FIG. 20.

In accordance with a second embodiment of the present invention, a computerized system and method are provided for authenticating and selling collectible items, the computerized system and method includes a celebrity, a video camera, such as a digital camera, a video editing system, a computer based encoding system, and VHS cassette or DVD. In one aspect of this embodiment, a recording session is set up to have a video image of a celebrity such a sports celebrity taken, signing sports memorabilia such as signed baseballs, hats, bats, jerseys), using the digital camera. This embodiment is not limited to sports memorabilia and/or sports celebrities, but may be used with any other collectible item and/or type of celebrity.

The sports memorabilia or collectible item is authenticated and sold together with the video image of the celebrity, in this case a sports celebrity, signing the item. In this aspect of the invention, the item is time and date stamped and stored. Preferably, the video image is an audio and video segment of the celebrity not only signing the item, but also acknowledging and/or thanking the person purchasing the item. In addition, preferably, the celebrity records a plurality of video segments for a plurality of customers in a single video and the video is edited by a video editing system linked to a computer based video encoding system producing individual segments for each individual customer. This allows a large number of video segments to be recorded in a relatively short time. Specifically, the computer based video encoding system encodes the single video into a separate file, one video computer file per collectible item. Preferably, simultaneously to or proximate in time to the editing of the single video onto a computer files, the computer based video encoding system also records each individual segment onto a VHS cassette or DVD.

Once the individual segment is recorded on the VHS cassette or DVD, it may sold to the customer along with the signed item. In this manner, the video segment can serve not only to authenticate the item, but also to provide a unique and personalized product which can be sold at a higher price than the signed item alone.

In accordance with a preferred embodiment of the invention, the entity selling the item also sponsors a website and the website includes web pages for each customer, and the video segments is posted on the web page so that the customer (or anyone who the customer gives the URL of the customer's web page to) can view the video segments at any time. As with the first embodiment of FIGS. 1-18, this embodiment also allows for viewing the image of the collectible item on the on-line title company's website via a customized we page for that collectible item.

In addition, in the second embodiment, the on-line title company's web site may also allow the video segments to be downloaded to the customer's computer. Password protection can also be provided if increased security is desired. A customer can place an order for a signed item either through the website, by telephone, by fax, or by mail.

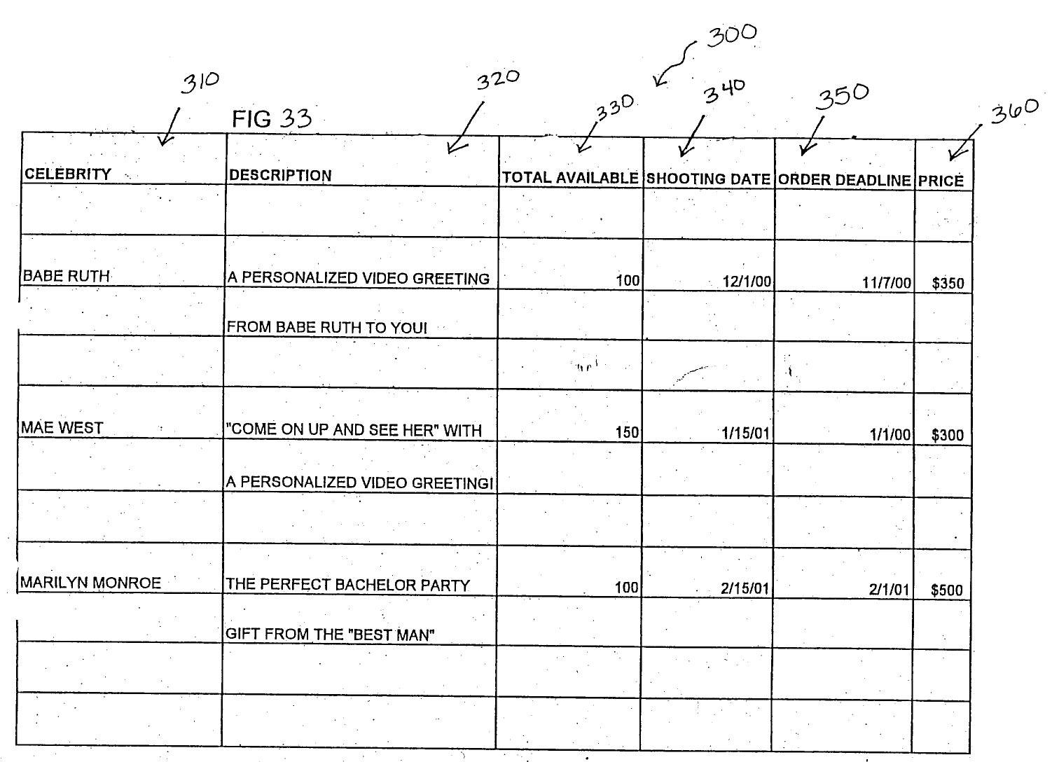

In a further aspect of the second embodiment, an individual may seek a personalized greeting from a celebrity for a collectible item and/or a personalized greeting alone. In this aspect of the present invention, a celebrity is retained by a company for providing a predetermined number of video greetings. A date for recording this greeting is set by all the parties. The purchasing information, as shown on form 300 in FIG. 33, for these greetings, such as the celebrity's name 310, description of the greeting 320, total number of predetermined greetings 330 available, shooting date 340, order deadline 350, and price of the greeting 360. The above purchasing information is made available to the public in a variety of different ways, including via the company's website, mail order, television, and radio. A consumer may place the order for one or more celebrity greeting by telephone, facsimile, or on the greeting company's website.

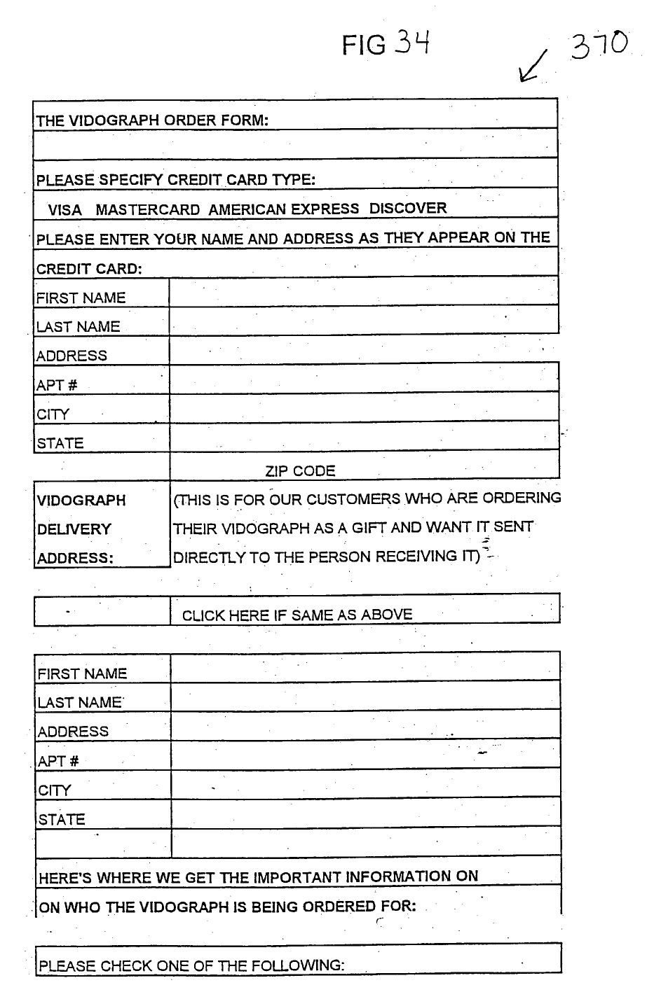

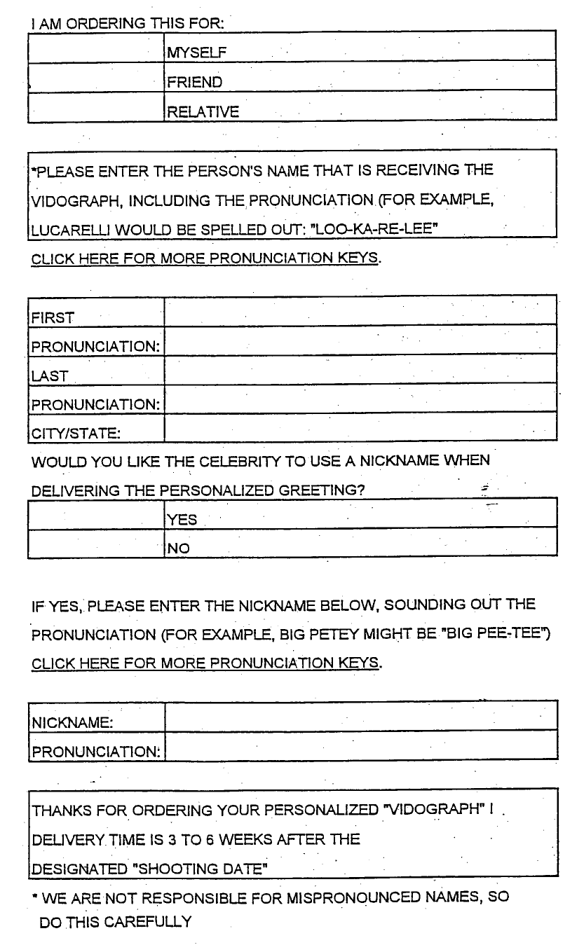

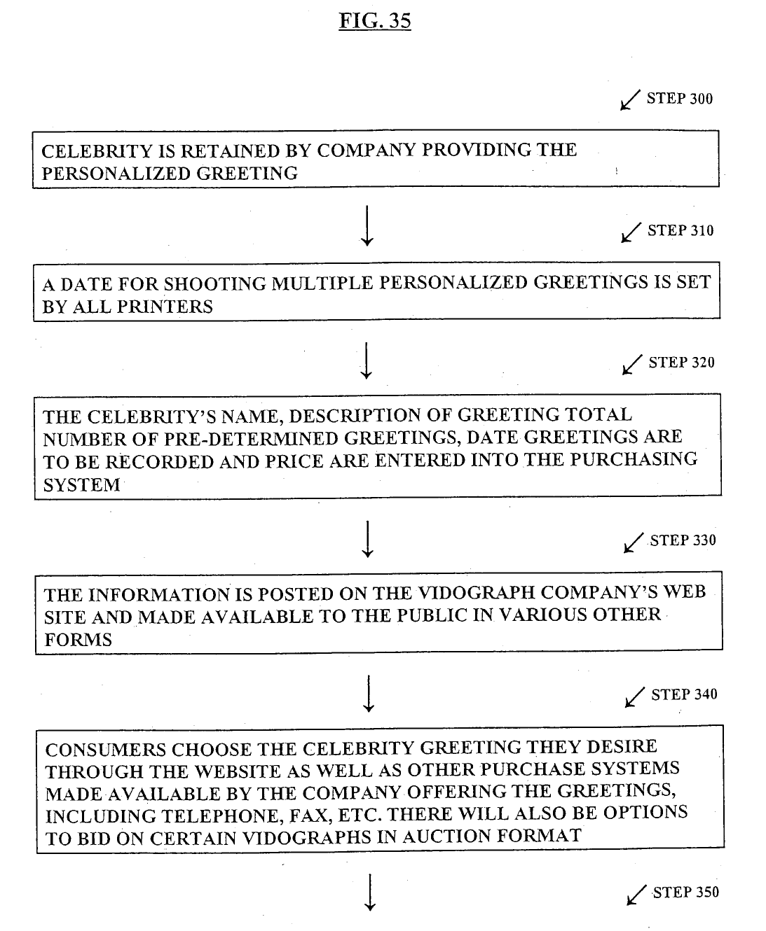

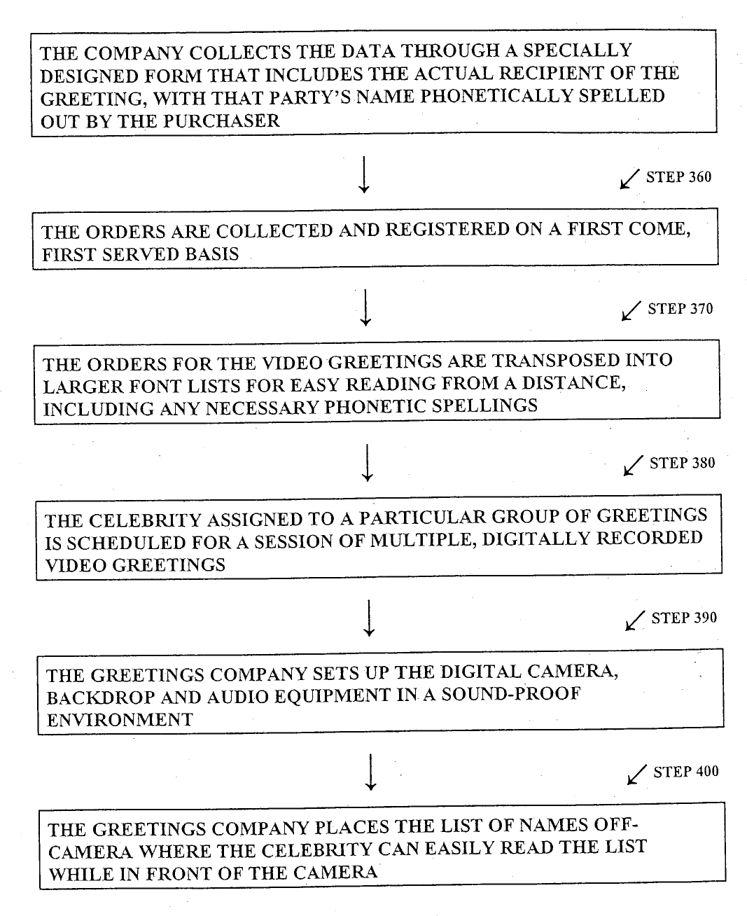

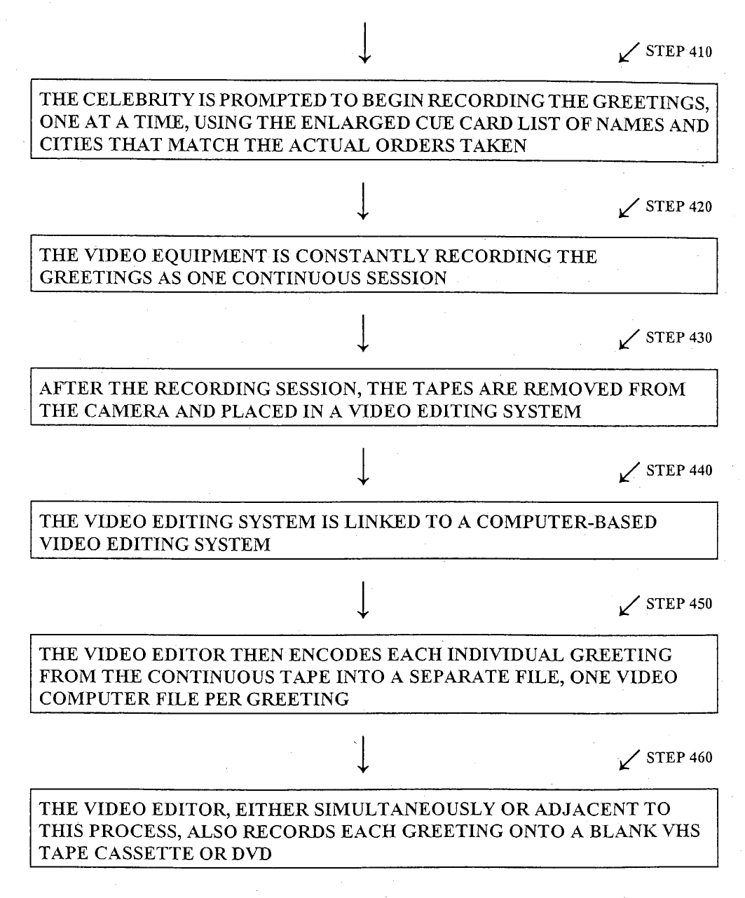

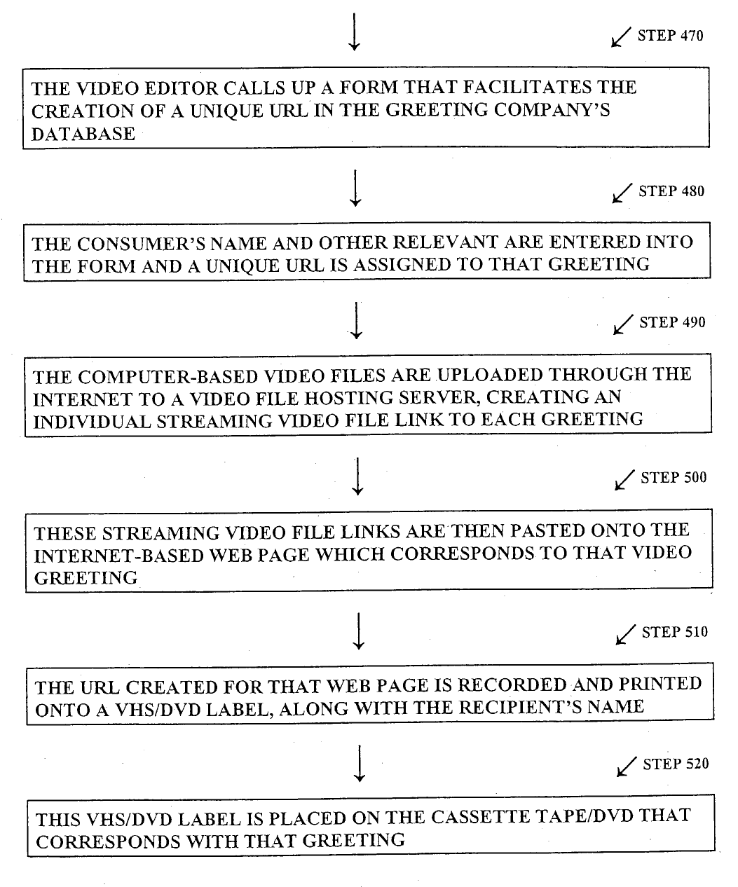

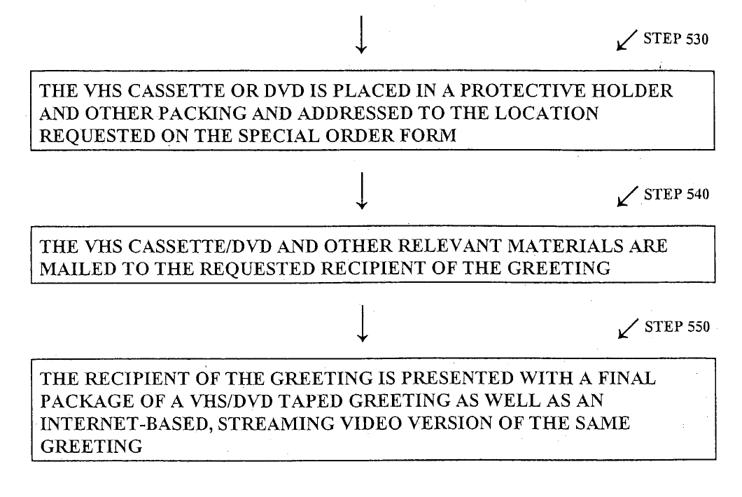

The personalized greeting may include the celebrity recognizing the recipient by their first and last name, nickname, city, and/or other identifying characteristics. The information regarding the recipient of the greeting is gathered, including the recipient's name phonetically spelled out. An example of the type of information that is requested by the company from the consumer is shown on form 310 in FIG. 34 Subsequently, the orders are collected and registered on a first come fist serve basis.

Once the final orders are processed, video session is set up for the celebrity to record a predetermined number of greetings, with enlarged cue cards being used for the celebrity to read the each recipients from. The video recording is then edited in much the same way as the video image of the first aspect of the second embodiment to produce individual video/audio segments, one computer file per greeting and one VHS cassette or DVD recording per greeting.

Finally, as with the first aspect of the second embodiment, each of these video/audio segments may be placed on its own customized web page of the greetings company web site and assigned a unique URL address and password, and where ownership changes may effected by the new owner with the assigned password by editing the owner's information fields on the web page.

An example of steps to be followed in practicing the second embodiment of the present invention are set forth in-flow diagram form in FIG. 35. Specifically, in step 300, the celebrity is retained by the company providing the personalized greeting with the specific purpose of recording a predetermined number of video greetings. A date for recording these greetings is set by all the parties, step 310. The celebrity's name, description of the greeting, total number of predetermined greetings, date greetings are to be recorded and price of each greeting are entered into the unique purchasing system, step 320. This information is then posted on the title company's website and made available to the public in various forms, including mail order, TV and radio, step 330. Consumers choose the celebrity greeting they desire through the company's website or other method of ordering, including fax, telephone, e-mail, etc, step 340.

The title company collects the data through a specifically designed form that includes the actual recipient of the greeting with that party's name phonetically spelled out by the purchaser, step 350. The orders are collected and registered on a first come, first serve basis, step 360. Subsequently, the orders for the video greetings are transposed into larger font cue cards for easy reading from a distance, including any necessary phonetic spellings, step 370.

The celebrity assigned to a particular group of greetings is then scheduled for a session of multiple, digitally recorded video greetings, step 380. The company sets up the digital camera, backdrop and audio equipment in a sound-proof environment, step 390. Next, the company places the lists of names off-camera where the celebrity can easily read the list while in front of the camera, step 400. The celebrity is prompted to begin recording the greeting, one at a time, using the enlarged cue card list of names and cities that match the actual orders taken, step 410. The video equipment is constantly recording the greetings as one continuous session, step 420.

After the recording session, the tapes are removed from the camera and placed in the video editing system, step 430. The video editing system is linked to the computer based video editing system, step 440. In step 450, the computer based video system encodes each individual greeting from a continuous tape onto a separate file, one video computer file per greeting. The computer based video editing system, either simultaneously or adjacent to this process, also records each greeting onto a blank VHS tape cassette or DVD, step 460. Further, the computer based video editing system then calls up a form that facilitates the creation of a unique URL address in the greeting company's database, step 470. Subsequently, the consumer's name and other relevant information are entered into the form and a unique URL is assigned to that greeting, step 480.

In step 490, computer-based video files are uploaded through the internet to a video file hosting server, creating an individual streaming video file link to each greeting. These streaming video file links are then pasted onto the internet-based web page which corresponds to that video greeting, step 500. The URL address created for that web page is recorded and printed onto a VHS/DVD label, along with the recipients name, step 510. This VHS/DVD label is placed onto the cassette tape/DVD which corresponds with that greeting, step 520.

The VHS cassette or DVD is then placed in a protective holder and other packaging and addressed to the location requested on the special order form, step 530. In step 540, the VHS cassette/DVD and other relevant materials are mailed to the requested recipient of the greeting. The recipient of the greeting is then presented with a final package of a VHSIDVD taped greeting as well as an internet-based, streaming video version of the same greeting, step 550.

The embodiments described above are not meant to be exclusive. Many other variations of the present invention would be obvious to those skilled in the art, and are contemplated to be within the scope of the appended claims.

What is claimed is:

1. An on-line system for authenticating a collectible item or other type of memorabilia comprising:
a website having a web page for the collectible item;
a unique URL address assigned to the web page; and
a unique password assigned to a current owner of the collectible item for editing ownership information displayed on the web page.

2. The on-line system of claim 1, wherein the collectible item further comprises an identifying mark that describes how the collectible item is part of a limited edition or series.

3. The on-line system of claim 1, further comprising a written description of the collectible item.

4. The on-line system of claim 1, further comprising a digital image of the collectible item located on the web page.

5. The on-line system of claim 1, further comprising a certificate or document having both the unique URL address of the web page for the collectible item and assigned password indicated thereon.

6. The on-line system of claim 1, wherein the collectible item is a baseball autographed by a major league baseball player.

7. An on-line title registration system for collectible items viewable by the general public via the internet comprising:
a website having a web page which includes a picture of the collectible item on the web page;
a unique URL address assigned to the web page;
a written description of the collectible item located on the web page;
a unique password assigned to a current owner of a collectible item and to an on-line title company; and
wherein the web page is accessible to the entire general public in read only format but where the ownership information on the web page may be edited by the owner of the collectible item and by the title company.

8. The on-line title registration system of claim 7, wherein the collectible item further comprises an identifying mark that describes how the collectible item is part of a limited edition or series.

9. The on-line title registration system of claim 7, wherein the picture on the web page of collectible item is a digital image.

10. The on-line title registration system of claim 7, further comprising a paper or document having both the unique URL address of the web page for the collectible item, the unique assigned password, and instructions on how to log onto the web page, indicated thereon.

11. The on-line system of claim 7, wherein the collectible item is a baseball autographed by a major league baseball player.

12. The on-line title registration system of claim 7, wherein the website has a text search engine which any member of the public may freely use to search the website for items of interest.

13. The on-line title registration system of claim 7, wherein the website further comprises a separate auction area in which the collectible item may be entered for auction.

14. A method for authenticating a collectible item or other type of memorabilia comprising the steps of:
creating the collectible item;
creating a web page for collectible item;
creating a unique URL address for the web page assigning the unique URL address to the web page;
creating a unique password for web page; and
assigning the unique password to the current owner of the collectible item and to title company for being able to edit ownership information on the web page.

15. The method of claim 14, further comprising preparing a paper or document having the URL address and password indicated thereon.

16. The method of claim 14, wherein an identifying mark that describes how the collectible item is part of a limited edition or series is placed on the collectible item before the digital image is taken.

17. The method of claim 14, further comprising preparing a written description of the collectible item.

18. The method of claim 14, wherein said collectible item is sold or otherwise given away by previous owner to a new owner and ownership is transferred to the new owner by the steps of:
transferring physical possession of the collectible item to the new owner;
transferring physical possession of the certificate or document having the URL address and password;
having the new owner log onto the web page for the collectible item via the URL address provided on said certificate or document; and
having the new owner enter the password provided on certificate or document to gain access to title page and supplement previous owner's information with the new owner's information.

19. A system for creating and merchandising celebrity greetings comprising:
a video camera for the continuous recording of a celebrity reciting a plurality of personalized greetings;
a VHS cassette or DVD for storing video image and audio of the celebrity reciting said greetings captured by said video camera;
a video editing system for editing the video image and audio of each greeting on said VHS cassette or DVD-onto a separate blank VHS cassette or DVD; and
a computer based video editing system; said video editing system is linked to said computer based video editing system, said computer based video editing system encodes each individual greeting from the VHS cassette or DVD into a separate file, one video computer file per greeting.
